(19) United States
(12) Patent Application Publication
(10) Pub. No.: US 2025/0262967 A1
(43) Pub. Date: Aug. 21, 2025

(54) CHARGING DEVICE

(71) Applicant: Honda Motor Co., Ltd., Tokyo (JP)

(72) Inventors: Ryuta Matsui, Saitama (JP); Takero Arima, Torrance, CA (US)

(21) Appl. No.: 18/444,131

(22) Filed: Feb. 16, 2024

(51) Int. Cl. B60L 53/35; B60L 53/16; B60L 53/18; B60L 53/66; E05F 15/70; H02J 7/00

(52) U.S. Cl. CPC B60L 53/35; B60L 53/16; B60L 53/18; B60L 53/66; H02J 7/0042; E05F 15/70; E05Y 2900/534

(57) ABSTRACT

A charging device for charging a vehicle includes a frame adapted to be mounted to an overhead structure of a garage having a garage door and a cable holder rotatably mounted on the frame. The charging device includes an electric cable wound around the cable holder and including a first end electrically connected to a power supply equipment, a charger adapted to be removably connected to the vehicle to charge the vehicle, connected to a second end of the electric cable, and configured to move between an up position and a down position, and an actuator operatively coupled with the cable holder. The charging device further includes a controller configured to determine an approach of the vehicle to the garage and control the actuator to lower the charger to the down position in response to the determination of the approach of the vehicle to the garage.

### BACKGROUND

The disclosed subject matter relates generally to a charging device. More particularly, the disclosed subject matter relates to a charging device mounted to an overhead structure of a parking space, for example, a garage to suitably control a lowering and raising of a charger.

Electric vehicles are generally charged via an Electric Vehicle Supply Equipment (EVSE). In a parking space, for example, a garage, while charging the electric vehicle, the electric cable connecting the EVSE to vehicle, generally, occupies a significant amount of space and is arranged on a floor of the garage, leading to entanglement of the cable, which is undesirable.

### SUMMARY

According to an embodiment of the disclosure, a charging device for charging a vehicle is provided. The charging device includes a frame adapted to be mounted to an overhead structure of a garage having a garage door and a cable holder rotatably mounted on the frame. The charging device includes an electric cable wound around the cable holder and including a first end electrically connected to a power supply equipment, a charger adapted to be removably connected to the vehicle to charge the vehicle, connected to a second end of the electric cable, and configured to move between an up position and a down position, and an actuator operatively coupled with the cable holder to operate the cable holder to wound the electrical cable on the cable holder and unwound the electrical cable from the cable holder to move the charger between the up position and the down position. The charging device further includes a controller configured to determine an approach of the vehicle to the garage and control the actuator to lower the charger to the down position in response to the determination of the approach of the vehicle to the garage.

According to an embodiment of the disclosure, a method is provided. The method includes providing a charging device including a frame mounted to an overhead structure of a garage and a cable holder rotatably mounted on the frame. The charging device includes an electric cable wound around the cable holder and including a first end electrically connected to a power supply equipment and a charger adapted to be removably connected to the vehicle to charge the vehicle and connected to a second end of the electric cable and configured to move between an up position and a down position. The method further includes determining by a controller of the charging device, an approach of a vehicle to the garage and controlling the cable holder to lower the charger to the down position in response to the determination of the approach of the vehicle to the garage.

According to another embodiment of the disclosure, a charging device for charging a vehicle is provided. The charging device may include a frame adapted to be mounted to an overhead structure of a garage having a garage door and a cable holder rotatably mounted on the frame. The charging device may further include an electric cable wound around the cable holder. The electric cable further includes a first end electrically connected to a power supply equipment. The charging device may include a charger adapted to be removably connected to the vehicle to charge the vehicle and connected to a second end of the electric cable and configured to move between an up position and a down position, the charger includes a switch adapted to be actuated by a user. The charging device may further include an actuator operatively coupled with the cable holder to operate the cable holder to wound the electrical cable on the cable holder and unwound the electrical cable from the cable holder to move the charger between the up position and the down position. The charging device may include a controller configured to determine an approach of the vehicle to the garage and control the actuator to lower the charger to the down position in response to determination of the approach of the vehicle to the garage and the controller configured to control the actuator to raise the charger to the up position from the down position in response to the actuation of the switch.

### BRIEF DESCRIPTION OF THE DRAWINGS

Certain embodiments of the present disclosure will be better understood from the following description taken in conjunction with the accompanying drawings in which:

FIG. 1 is a schematic view of a charging device mounted to a roof of a garage and having a charger arranged at a charging position, in accordance with one embodiment of the present disclosure;

FIG. 2 is a schematic view of the charging device mounted to the roof of the garage and depicting the charger arranged at a stowed position, in accordance with one embodiment of the present disclosure; and

FIG. 3 is a block diagram depicting the charging device arranged in communication with a vehicle, a garage door, and a mobile device, in accordance with one embodiment of the present disclosure.

### DETAILED DESCRIPTION OF EXEMPLARY EMBODIMENTS

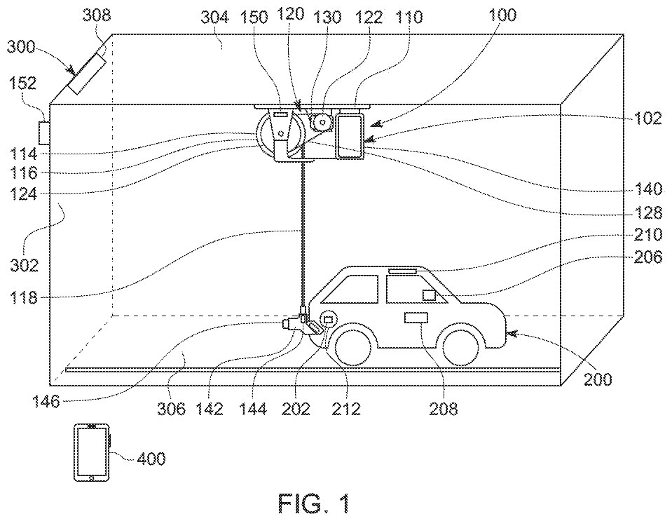

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-3, wherein like numbers indicate the same or corresponding elements throughout the views.

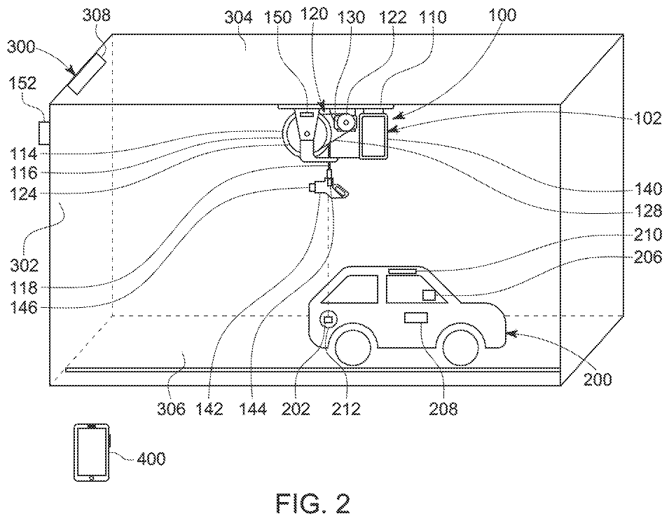

FIGS. 1 and 2 illustrate a charging device 100 for charging electric components, for example, an electric vehicle 200, in accordance with an example embodiment of the disclosure. The charging device 100 is an overhead charging device 102 fixedly or slidably mounted to an overhead or elevated structure, for example a roof 304 of a garage 300 or a parking area. As shown, the charging device 100 includes a frame 110 mounted to the overhead structure and supporting various components of the charging device 100. To facilitate the movement of the charging device 100 relative to the overhead structure, in some embodiments, the frame 110 may include one or more guide rails, which may be configured to be fastened with an additional support (not shown) at a height above a floor surface 306 of the garage 300.

Moreover, the charging device 100 includes a cable holder 114, for example, a drum 116, rotatably coupled to the frame 110 and an electric cable 118 at least partially wound around the drum 116. The electric cable 118 is unwound/unreeled from the drum 116 to enable a charging of an electric vehicle 200 disposed inside the garage 300 and is retracted back and wound/reeled back around the drum 116 upon charging of the electric vehicle 200. To enable the extension/unwinding of the electric cable 118 from the drum 116 and retraction or reeled back of the cable 118 on the drum 116, the charging device 100 includes a drive assembly 120.

In the illustrated embodiments, the drive assembly 120 is a belt-pulley assembly having a drive pulley 122 rotatably mounted to the frame 110 and arranged to rotate relative to the frame 110 about its central axis, a driven pulley 124 coupled to the drum 116 to rotate the drum 116 in response to the rotation of the drive pulley 122. Moreover, the drive assembly 120 includes a belt 128 extending from the drive pulley 122 to the driven pulley 124 to rotate the driven pulley 124, hence the drum 116 in response to the rotation of the drive pulley 122. To rotate the drive pulley 122, the charging device 100 includes an actuator 130, for example, an electric motor 130, and the drive pulley 122 may be suitably arranged and coupled/connected/engaged with the electric motor 130 such that the drive pulley 122 rotates in response to an operation/actuation of the electric motor 130. In an embodiment, the drive pulley 122 is mounted to a motor shaft of the electric motor 130. Although the drive assembly 120 is shown and contemplated to include a belt-pulley assembly, it may be appreciated that drive assembly 120 may include any other mechanism, such as, but not limited to, a gear drive, a chain sprocket mechanism, or even a direct drive in which the drum 116 is mounted on the motor shaft, or any other mechanism suitable to rotate the drum 116 to enable retraction and/or the extension of the cable from the drum 116. In some embodiments, the electric motor 130 is a bi-directional motor.

The electric cable 118 may include one or more electric wires which may be configured to transmit electrical power or signals from a source location for example, a power supply equipment 140 to a charger 142 attached at an end of the cable 118 that moves up and down in response to the rotation of the drum 116. In an embodiment, the power supply equipment 140 may be an electric vehicle supply equipment, which may be configured to move on the guide rail. For example, the power supply equipment 140 may supply electric power via the electric cable 118, to charge the electric vehicle 200. The power supply equipment 140 may include an AC power source or a DC power source that may deliver the electric power to the electric vehicle 200 via the electric cable 118 wounded on the drum 116. Examples of the power supply equipment 140 may include one of: a standard household 120-volt power source, or a 240-volt power source, or other fast charging power sources (such as a DC fast charging power source, or a battery pack), which may be disposed at the floor surface 306 of the garage 300 or the frame 110 of the charging device 100.

The charger 142 may include a suitable design, shape, and structure, which may be configured to be coupled at the end of the electric cable 118 is adapted to move between a stowed position (i.e., up position), shown in FIG. 2, and a charging position (i.e., down position), shown in FIG. 1. In an embodiment, the charger 142 may be coupled with the end of the electric cable 118, via a mechanical fastener (not shown). As shown, the charger 142 includes a switch 144 adapted to be operated by a user to actuate the drive assembly 120 (i.e., electric motor 130) to reel in the electric cable 118 on the drum 116 and raise the charger 142 and position the charger 142 at the stowed position above a certain height from the floor surface 306 of the garage 300.

In an embodiment, the charger 142 may further include an electric contact 146, which may be configured to connect with a socket 202 associated with a battery of the electric vehicle 200. In an embodiment, the electric contact 146 may be formed as a plurality of connector pins that may protrude from a portion (not shown) of the charger 142. The plurality of connector pins may be aligned and mate with the socket 202 to charge the electric vehicle 200.

Further, to control various electrical and electronic components of the charging device 100, the charging device 100 includes a controller 150 to control the lowering and raising of the charger 142 to enable the charging of the electric vehicle 200. In an embodiment, the controller 150 is configured to detect/determine that the vehicle 200 is approaching the garage 300, and initiates the lowering of the charger 142 upon detection of the approach of the vehicle 200 to the garage 300. In some embodiments, the controller 150 may determine the approach of the vehicle 200 based on an input received from the vehicle 200 and/or a garage door 302. For example, the device 100 may include a sensor 152 to detect the vehicle 200 in a vicinity of the garage 300, and upon detection of the vehicle 200, based on the input from the sensor 152, the controller 150 is arranged to initiate the opening of the garage door 302 and lowering of the charger 142. In some embodiments, the controller 150 is arranged in communication with a garage door opener 308 and configured to activate the actuator/electric motor 130 and hence the drive assembly 120 to lower the charger 142 upon detection of the opening of the garage door 302 based on the input received from the garage door opener 308.

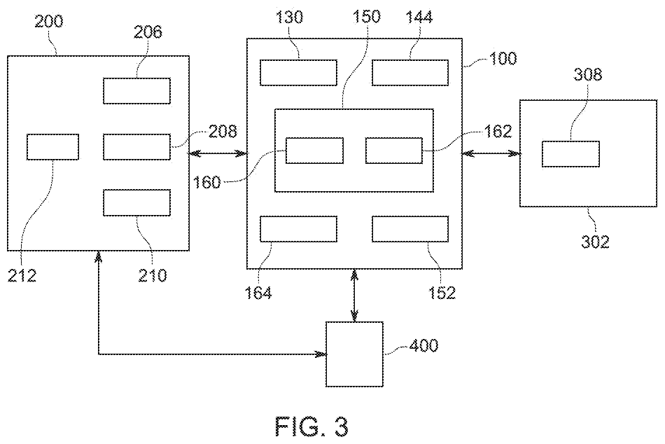

In some embodiments, as shown in FIG. 3, the controller 150 may be arranged to communicate with a user interface 206 of the vehicle 200 or a vehicle controller 208, and actuates the actuator/electric motor 130 to lower the charger 142 based on a command, for example, a voice command input or an actuation of a switch of the user interface 206, by a driver of the vehicle 200. It may be appreciated that the controller 150 actuates the lowering of the charger 142 based on the command received from the vehicle 200 when the vehicle 200 is within a predefined distance from the parking space of the garage door 302. In some embodiments, the vehicle 200 may include a short-range communication device 210, for example, a Bluetooth or a near field communication (NFC) device, and the controller 150 may be configured to initiate the lowering of the charger 142 upon detection of the such short range communication device 210 based on a signal received from the short range communication device 210.

In addition to the lowering of the charger 142, the controller 150 is configured to communicate with the garage door opener 308 to enable the opening of the garage door 302 based on the input received from the vehicle 200. It may be appreciated that the controller 150 is configured to authenticate the vehicle 200 before initiating the lowering of the charger 142 as well as opening of the garage door 302.

Further, in some embodiments, the controller 150 is arranged in communication with a vehicle controller 208 and facilitates an opening a charging lid 212 covering the socket 202 upon parking of the vehicle 200 inside the garage 300. Further, the controller 150 is arranged in communication with a mobile device 400 of a user/owner of the vehicle 200 and shares a notification to the mobile device 400 to inform a charging status of the vehicle 200. In some embodiments, the controller 150 may receive an input/information related to the completion of charging of the vehicle 200 from the vehicle controller 208, and controls the power supply equipment 140 to electrically disconnect the charger 142 from the battery of the vehicle 200. In some embodiments, the controller 150, upon determining the completion of the charging of the vehicle 200, raises an alarm to inform the vehicle driver to prompt the vehicle's user to disconnect the charger 142 from the socket 202 of the vehicle 200.

To enable the raising of the charger 142 to the stowed position i.e., at a predetermined height from the floor of the garage 300, the charger 142 includes the switch 144 adapted to be pressed or actuated by the user. In response to pressing of the switch 144, the controller 150 activates the actuator/electric motor 130 and operates the actuator 130 to rotate the drum 116 to reel in the electric cable 118 on the drum 116. In some embodiments, the controller 150 may detect a disengagement of the charger 142 from the socket 202, and automatically operates the actuator 130 based on such detection. It may be appreciated that the controller 150 may actuate the actuator/electric motor 130 if the charger 142 remains disengaged from the socket 202 for a predetermined time duration.

In some embodiments, the vehicle controller 208 is arranged to disengage the charger 142 from the socket 202 upon detection of the completion of charging of the battery of the vehicle 200. In such a case, the controller 150 receives such information from the vehicle controller 208, and actuates the actuator/electric motor 130 to raise the charger 142 upon disengagement of the charger 142 from the socket 202 without waiting for the elapse of the predetermined time duration from the disengagement of the charger 142 from the socket 202. In this manner, the charging device 100 facilitates an easy and efficient charging of the electric vehicle 200 without having the entangled wires/cables disposed inside the garage 300. Also, as the charging device 100 is located at the height above the floor surface 306 i.e., proximate to the roof 304 of the garage 300 or the cable holder 114 in the stowed position, a significant amount of space is saved on the floor surface 306, which may be used to for other purpose.

In the embodiments, as shown in FIG. 3, the controller 150 may include a processor 160 for executing specified instructions, which controls and monitors various functions associated with charging device 100. The processor 160 may be operatively connected to a memory 162 for storing instructions related to the control of the charging device 100 and components of the charging device 100. The memory 162 as illustrated is integrated into the controller 150, but those skilled in the art will understand that the memory 162 may be separate from the controller 150 but onboard the charging device 100, and/or remote from the controller 150 and the charging device 100, while still being associated with and accessible by the controller 150 to store information in and retrieve information from the memory 162 as necessary during the operation of charging device 100. Although the processor 160 is shown, it is also possible and contemplated to use other electronic components such as a microcontroller, an application specific integrated circuit (ASIC) chip, or any other integrated circuit device. Moreover, the controller 150 may refer collectively to multiple control and processing devices across which the functionality of the charging device 100 may be distributed. For example, the actuator 130, the sensor 152, and the charger 142 may each have one or more controllers that communicate with the controller 150. Moreover, the charging device 100 may include at least one communication device 164 to enable the communication of the controller i.e., charging device 100 with the vehicle 200, one or more components of the garage 300, and/or the mobile device 400. In an embodiment, the at least one communication device 164 may be a short-range communication device and/or a long range communication device.

The foregoing description of embodiments and examples has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A charging device for charging a vehicle, the charging device comprising:
a frame adapted to be mounted to an overhead structure of a garage having a garage door;
a cable holder rotatably mounted on the frame;
an electric cable wound around the cable holder and including a first end electrically connected to a power supply equipment;
a charger adapted to be removably connected to the vehicle to charge the vehicle and connected to a second end of the electric cable and configured to move between an up position and a down position;
an actuator operatively coupled with the cable holder to operate the cable holder to wound the electrical cable on the cable holder and unwound the electrical cable from the cable holder to move the charger between the up position and the down position; and
a controller configured to determine an approach of the vehicle to the garage and control the actuator to lower the charger to the down position in response to the determination of the approach of the vehicle to the garage.

2. The charging device of claim 1, wherein the controller is configured to determine the approach of the vehicle based on a signal received from the vehicle.

3. The charging device of claim 2, wherein the vehicle includes a short range communication device and the controller determines the approach of the vehicle based on the signal received from the short range communication device.

4. The charging device of claim 1, wherein the controller is configured to determine an opening of the garage door and determine the approach of the vehicle based on the opening of the garage door.

5. The charging device of claim 4, wherein the garage includes a garage door opener configured to open the garage door and the controller is arranged in communication with the garage door opener and determines the approach of the vehicle based on input from the garage door opener.

6. The charging device of claim 1 further comprising a sensor to detect an approach of the vehicle and the controller operates the actuator based on input from the sensor.

7. The charging device of claim 1, wherein the charger includes a switch adapted to be operated by a user to actuate the actuator to raise the charger to the up position.

8. The charging device of claim 1, wherein the controller is arranged to communicate with a vehicle controller to open a charging lid of the vehicle upon actuation of the actuator to lower the charger to the down position.

9. The charging device of claim 1 further comprising a drive assembly operatively coupling the actuator with the cable holder to rotate the cable holder in response to the actuation of the actuator.

10. The charging device of claim 9, wherein the drive assembly includes a belt-pulley assembly having a driven pulley operatively coupled to the cable holder and a drive pulley operatively coupled to the actuator and configured to rotate the driven pulley.

11. A method, comprising:
providing a charging device including
a frame mounted to an overhead structure of a garage,
a cable holder rotatably mounted on the frame,
an electric cable wound around the cable holder and including a first end electrically connected to a power supply equipment,
a charger adapted to be removably connected to the vehicle to charge the vehicle and connected to a second end of the electric cable and configured to move between an up position and a down position, and
determining, by a controller of the charging device, an approach of a vehicle to the garage; and
controlling the cable holder to lower the charger to the down position in response to the determination of the approach of the vehicle to the garage.

12. The method of claim 11, wherein the controller is configured to determine the approach of the vehicle based on a signal received from the vehicle.

13. The method of claim 12, wherein the vehicle includes a short range communication device and the controller determines the approach of the vehicle based on the signal received from the short range communication device.

14. The method of claim 11, wherein the controller is configured to determine an opening of the garage door and determine the approach of the vehicle based on the opening of the garage door.

15. The method of claim 11, wherein the charging device further comprises a sensor to detect an approach of the vehicle and the controller operates the cable holder based on input from the sensor.

16. The method of claim 11, wherein the charger includes a switch adapted to be operated by a user to operate the cable holder to raise the charger to the up position.

17. A charging device for charging a vehicle, the charging device comprising:
a frame adapted to be mounted to an overhead structure of a garage having a garage door;
a cable holder rotatably mounted on the frame;
an electric cable wound around the cable holder and including a first end electrically connected to a power supply equipment;
a charger adapted to be removably connected to the vehicle to charge the vehicle and connected to a second end of the electric cable and configured to move between an up position and a down position, the charger includes a switch adapted to be actuated by a user;
an actuator operatively coupled with the cable holder to operate the cable holder to wound the electrical cable on the cable holder and unwound the electrical cable from the cable holder to move the charger between the up position and the down position; and
a controller configured to
determine an approach of the vehicle to the garage and control the actuator to lower the charger to the down position in response to the determination of the approach of the vehicle to the garage, and
control the actuator to raise the charger to the up position from the down position in response to the actuation of the switch.

18. The charging device of claim 17, wherein the controller is configured to determine the approach of the vehicle based on a signal received from the vehicle.

19. The charging device of claim 17, wherein the controller is configured to determine an opening of the garage door and determine the approach of the vehicle based on the opening of the garage door.

20. The charging device of claim 17 further comprising a sensor to detect an approach of the vehicle and the controller operates the actuator based on input from the sensor.
